(19) United States
(12) Patent Application Publication
(10) Pub. No.: US 2023/0363354 A1
(43) Pub. Date: Nov. 16, 2023

(54) Animal Harnesses and Related Methods

(71) Applicant: Dennison Lee Terhaar, North Salt Lake, UT (US)

(72) Inventor: Dennison Lee Terhaar, North Salt Lake, UT (US)

(21) Appl. No.: 18/306,585

(22) Filed: Apr. 25, 2023

Related U.S. Application Data
(60) Provisional application No. 63/364,649, filed on May 13, 2022.

(51) Int. Cl. A01K 27/00

(52) U.S. Cl. CPC A01K 27/002; A01K 27/001

(57) ABSTRACT

An animal harness may include a collar coupler and a back strap coupled therewith and extending toward hind legs of the animal. A strap coupler may be coupled with the back strap. A first belly strap may be coupled with the strap coupler and with a first attachment member. A second belly strap may be coupled through an opening of the strap coupler and slidable therethrough and may be coupled with a second attachment member. A leash coupler may be coupled with the second belly strap or integrally formed therewith. The first and second attachment members may be secured together so the first and second belly straps form a loop around a waist or belly area of the animal. The loop may tighten around the animal, due to the second belly strap being slidable through the opening of the strap coupler, in response to a pulling force.

### CROSS REFERENCE TO RELATED APPLICATIONS

This document claims the benefit of the filing date of U.S. Provisional Patent Application Ser. No. 63/364,649, entitled “Pet Harnesses and Related Methods,” naming as first inventor Dennison Lee Terhaar, which was filed on May 13, 2022, the disclosure of which is hereby incorporated entirely herein by reference.

### BACKGROUND

### 1. Technical Field

Aspects of this document relate generally to devices for restraining and/or guiding animals. Particular aspects of this document relate generally to devices for restraining and/or guiding quadrupedal animals and pets.

### 2. Background Art

Leashes, collars, muzzles, and other items exist in the art for restraining and/or guiding animals, including pets. Animal harnesses exist in the art which are secured around an animal proximate its front legs. These sometimes include a portion that couples at the animal's chest in front of its front legs and a portion that couples at its torso just behind its front legs. Various training collars exist such as slip collars, choking collars, prong collars, pinch collars, and martingale collars (the latter of which provides control over an animal without the choking effect of a slip collar). A dog leash also exists in the art which couples with a dog collar, reaches back to and encircles the dog's torso proximate its rear legs, and includes an extended portion extending therefrom to the user's hand or arm for a user to hold the leash and/or restrain the dog.

### SUMMARY

In some aspects, the techniques described herein relate to an animal harness, including: a collar coupler configured to be coupled with a collar of an animal; a back strap coupled with the collar coupler and configured to extend toward hind legs of the animal along one of a back of the animal and a side of the animal; a strap coupler coupled with the back strap; a first belly strap coupled with the strap coupler; a first attachment member coupled with the first belly strap; a second belly strap coupled through an opening of the strap coupler and slidable therethrough; a second attachment member coupled with the second belly strap; and a leash coupler one of coupled with the second belly strap and integrally formed with the second belly strap, the leash coupler configured to couple with a leash; wherein the first attachment member and the second attachment member are configured to be releasably secured together such that the first belly strap and the second belly strap form a loop around one of a waist area of the animal and a belly area of the animal; and wherein the loop is configured to tighten around the animal, due to the second belly strap being slidable through the opening of the strap coupler, in response to a pulling force exerted by one of the animal and a user holding the leash.

In some aspects, the techniques described herein relate to an animal harness, wherein the strap coupler forms a closed loop.

In some aspects, the techniques described herein relate to an animal harness, wherein the closed loop is circular.

In some aspects, the techniques described herein relate to an animal harness, wherein the back strap includes a length adjuster configured to allow manual adjustment of a length of the back strap.

In some aspects, the techniques described herein relate to an animal harness, further including a swivel member coupling the collar coupler with the back strap and configured to allow the collar coupler to swivel relative to the back strap.

In some aspects, the techniques described herein relate to an animal harness, wherein the collar coupler is configured to be secured to the collar and is further configured to be manually releasable therefrom.

In some aspects, the techniques described herein relate to an animal harness, wherein the collar coupler includes a clip biased to a closed configuration and manually movable to an open configuration.

In some aspects, the techniques described herein relate to an animal harness, wherein the back strap is slidably coupled with the strap coupler.

In some aspects, the techniques described herein relate to an animal harness, wherein the first belly strap is slidably coupled with the strap coupler.

In some aspects, the techniques described herein relate to an animal harness, wherein the second belly strap includes a length adjuster configured to allow manual adjustment of a length of the second belly strap.

In some aspects, the techniques described herein relate to an animal harness, wherein the length adjuster of the second belly strap is too large to pass through the opening of the strap coupler.

In some aspects, the techniques described herein relate to an animal harness, wherein the second attachment member is too large to pass through the opening of the strap coupler.

In some aspects, the techniques described herein relate to an animal harness, wherein the back strap is fixedly secured to the strap coupler but is slidable thereon, and wherein the first belly strap is fixedly secured to the strap coupler but is slidable thereon.

In some aspects, the techniques described herein relate to an animal harness, wherein the loop has a minimum length and a maximum length, each of which is determined at least in part by an inability of a length adjuster of the second belly strap to fit through the opening or an inability of the second attachment member to fit through the opening.

In some aspects, the techniques described herein relate to an animal harness, including: a collar coupler configured to be coupled with a collar of an animal; a back strap coupled with the collar coupler and configured to extend toward hind legs of the animal along one of a back of the animal and a side of the animal, the back strap including a length adjuster configured to allow manual adjustment of a length of the back strap; a strap coupler slidably coupled with the back strap, the strap coupler forming a loop; a first belly strap slidably coupled with the strap coupler; a first attachment member coupled with the first belly strap; a second belly strap coupled through an opening of the strap coupler and slidable therethrough; a second attachment member coupled with the second belly strap; and a leash coupler coupled with the second belly strap, the leash coupler configured to couple with a leash; wherein the first attachment member and the second attachment member are configured to be releasably secured together such that the first belly strap and the second belly strap form a loop around one of a waist area of the animal and a belly area of the animal; wherein one of the first belly strap and the second belly strap includes a second length adjuster configured to allow manual adjustment of a length of the loop formed by the first belly strap and the second belly strap; and wherein the loop is configured to tighten around the animal, due to the second belly strap being slidable through the opening of the strap coupler, in response to a pulling force exerted by one of the animal and a user holding the leash.

In some aspects, the techniques described herein relate to an animal harness, wherein the second belly strap includes the second length adjuster, and wherein the second length adjuster is too large to pass through the opening of the strap coupler.

In some aspects, the techniques described herein relate to an animal harness, wherein the second attachment member is too large to pass through the opening of the strap coupler.

In some aspects, the techniques described herein relate to an animal harness, wherein the loop has a minimum length and a maximum length, each of which is determined at least in part by an inability of the second length adjuster to fit through the opening or an inability of the second attachment member to fit through the opening.

In some aspects, the techniques described herein relate to a method of use of an animal harness, including: coupling a collar coupler of the animal harness with a collar of an animal, wherein the animal harness includes: a back strap; a strap coupler coupled with the back strap; a first belly strap coupled with the strap coupler; a first attachment member coupled with the first belly strap; a second belly strap coupled through an opening of the strap coupler and slidable therethrough; a second attachment member coupled with the second belly strap; and a leash coupler one of coupled with the second belly strap and integrally formed with the second belly strap; extending the back strap toward hind legs of the animal along one of a back of the animal and a side of the animal; releasably securing the first attachment member and the second attachment member together such that the first belly strap and the second belly strap form a loop around one of a waist area of the animal and a belly area of the animal; coupling a leash with the leash coupler; and tightening the loop around the animal, due to the second belly strap being slidable through the opening of the strap coupler, in response to a pulling force exerted by one of the animal and a user holding the leash.

In some aspects, the techniques described herein relate to a method of use of an animal harness, further including preventing the loop from decreasing to below a minimum length and preventing the loop from increasing to above a maximum length, each of which is facilitated at least in part by an inability of a length adjuster of the second belly strap to fit through the opening or an inability of the second attachment member to fit through the opening.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a front, top, left side view of an implementation of an animal harness in a secured configuration (i.e., a configuration wherein the animal harness is secured to an animal);

FIG. 2 is a top view of elements of the animal harness of FIG. 1 in a non-secured configuration (i.e., a configuration wherein the animal harness is not secured to an animal);

FIG. 3 is a left side view of elements of the animal harness of FIG. 1 in a non-secured configuration;

FIG. 4 is a top, rear, left side view of portions of the animal harness of FIG. 1, representatively illustrating a step of securing the animal harness to a collar of an animal;

FIG. 5 is a top, rear, left side view of the animal harness of FIG. 1, representatively illustrating a step of securing the animal harness to an animal;

FIG. 6 is a top, rear, left side view of the animal harness of FIG. 1, representatively illustrating another step of securing the animal harness to an animal;

FIG. 7 is a top, rear, left side view of the animal harness of FIG. 1, representatively illustrating another step of securing the animal harness to an animal;

FIG. 8 top, rear, left side view of the animal harness of FIG. 1, representatively illustrating a step of securing a leash to the animal harness;

FIG. 9 is front, top, right side view of the animal harness of FIG. 1 in a secured configuration;

FIG. 10A is a left side view of a prior art leash and collar being used to restrain an animal; and

FIG. 10B is a left side view of the animal harness of FIG. 1 being used to restrain an animal.

### DESCRIPTION

Implementations/embodiments disclosed herein (including those not expressly discussed in detail) are not limited to the particular components or procedures described herein. Additional or alternative components, assembly procedures, and/or methods of use consistent with the intended animal harnesses and related methods may be utilized in any implementation. This may include any materials, components, sub-components, methods, sub-methods, steps, and so forth.

Implementations of animal harnesses and related methods relate to devices and methods for walking and restraining animals such as dogs, cats, other quadrupeds or animals which at least sometimes ambulate quadrupedally, and so forth, whether pets or otherwise.

Many people keep animals as pets or companion animals at home or in other places. Popular pets include dogs and cats, among other animals. The pets are generally controlled using a leash. Pets such as dogs naturally pull when on a leash. It is generally difficult to train the pets not to pull. Additionally, in other settings, animals that are not necessarily pets need to be restrained and prevented from escaping or otherwise prevented from some movement (such animals could include a stray dog or stray cat or any other quadruped or animal which at least sometimes ambulates quadrupedally).

In order to overcome the above issues, harnesses, leashes and/or collars are used. Traditional harnesses have much bigger limits on their ability to adjust size to fit an animal as it grows over time. Further, traditional collars and harnesses are attached far forward on an animal (proximate its front legs) and often get caught up in the animal's legs or get trapped under the animal, or otherwise increase the odds of an attached leash getting caught up in the animal's legs or getting trapped under the animal. This can lead to injury and/or frustration of the animal and/or user (i.e., the user walking the animal), and can result in the leash being yanked out of the hand or control of the user, and the animal escaping.

Other no-pull devices do not work effectively and/or are difficult to put on, such as chest harnesses and head halters and can cause pain and/or pose a high risk of injuring the animal, such as pinch, spike, or martingale collars.

Further, other harnesses and devices for animals that use cinching or tightening either limit the amount they can cinch, or they have no way to keep from getting too loose, so that animals can get out of them if the owners/users are not applying constant tension.

In order to overcome the above-discussed problems and other issues, the present subject matter discloses a unique harness that moves a point of attachment of a leash far back on the animal.

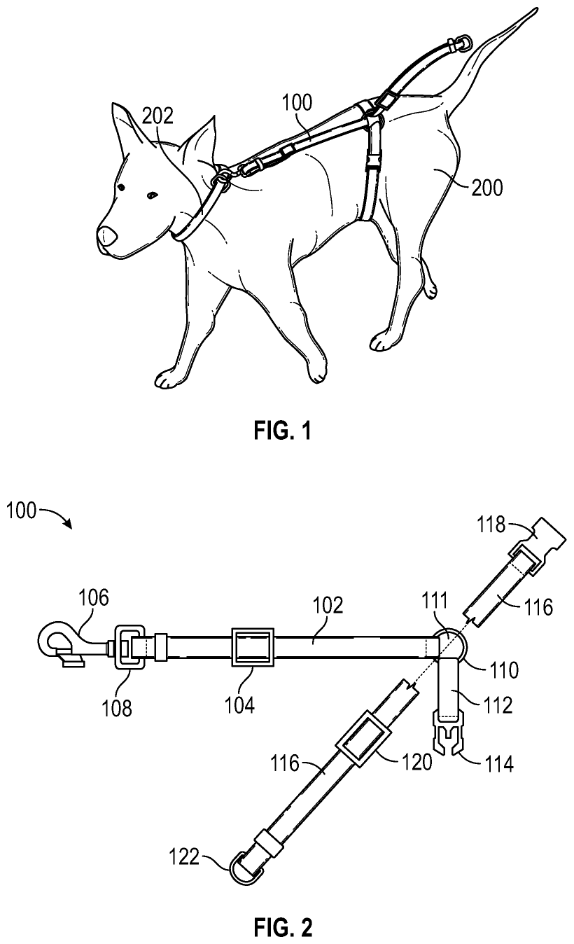

Referring now to FIG. 1, an animal harness 100 secured to an animal 200 at its waist area is shown in accordance with one embodiment of the present subject matter. Animal 200 includes, but is not limited to, a dog, a cat, or any other quadruped or animal which at least sometimes ambulates quadrupedally. In accordance with the present subject matter, animal harness 100 connects to or couples with collar 202 at or proximate the neck of animal 200 and moves a point of attachment of a leash far back on the animal 200.

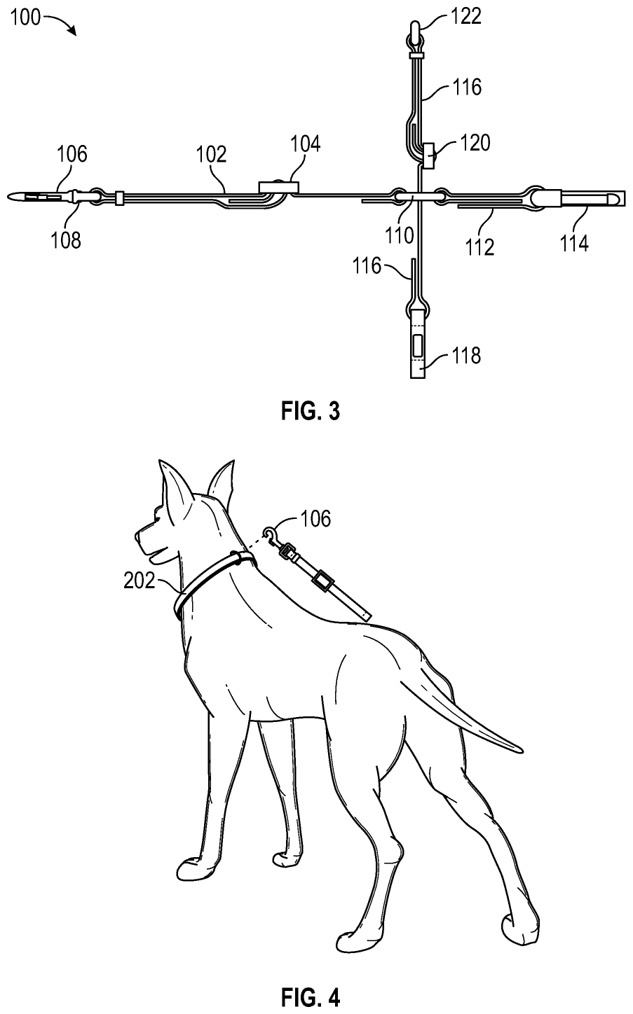

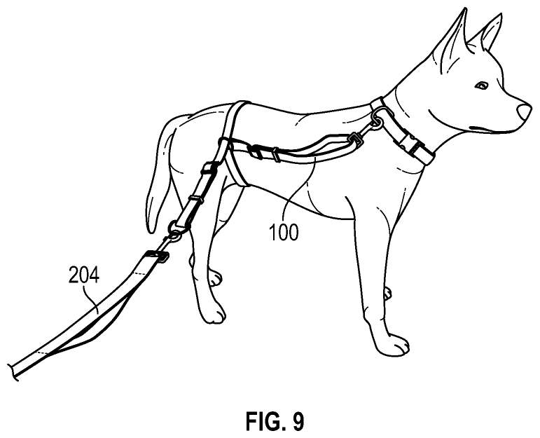

FIGS. 2 and 3 show top and side views, respectively, of elements of animal harness 100, in accordance with one embodiment of the present subject matter. Harness 100 includes an adjustable back strap 102. Adjustable back strap 102 could by non-limiting example be made of a fabric, leather, cord, rope, cloth, or any other rigid or flexible material. Rigid and flexible materials each have their advantages and tradeoffs, for example having it made of a flexible material (such as woven or braided cords or fabric) allows ease of length adjustment and also a compact configuration for storage. Adjustable back strap 102 includes a length adjuster 104. Length adjuster 104 allows for adjustment of the length of adjustable back strap 102. The adjustable back strap may extend along the animal's back (as in FIG. 1) or along the animal's side (as in FIG. 9). In one example, length adjuster 104 includes a tri-glide or sliding tension lock. Length adjuster 104 is affixed (in some cases permanently, in others removably) to an end of the adjustable back strap but the rest of the adjustable back strap slides within the length adjuster 104 with manual force and retains any given position (such as through a friction fit) when manual force is withdrawn, thus allowing for length adjustment of adjustable back strap 102 to a desired fixed length. In implementations the length adjuster 104 is permanently affixed to an end of the adjustable back strap, the adjustable back strap running from the length adjuster 104 through the releasable collar coupler 106, then back through the length adjuster 104, then the other end of the adjustable back strap permanently affixed to the strap coupler 110.

As indicated above, adjustable back strap 102 includes a releasable collar coupler 106 at one end and a strap coupler 110 at the other end. The collar coupler is not permanently affixed to any point along the adjustable back strap, allowing the collar coupler to slide to a distal end of the adjustable back strap regardless of the adjusted length of the adjustable back strap. In implementations collar coupler 106 includes a biased clip (biased towards a closed configuration but the bias being overcome with manual force) used for connecting adjustable back strap 102 to collar 202, though in other implementations other mechanisms for connecting to a collar could be used. Adjustable back strap 102 is coupled with a swivel member 108 having a hole. In the present subject matter, collar coupler 106 swivels through the hole provided in swivel member 108. Strap coupler 110 includes a ring-like structure in the shown implementation (such that it forms a closed loop), but in other implementations it could have any other shape such as rectangular, triangular, or any other polygon or regular or irregular shape. For example, the strap coupler could form a non-circular closed loop, or even a loop of any shape that is not closed but includes a gap, albeit not a gap large enough to, alone or in combination with opening 111, allow sufficient space for second attachment member 118 or length adjuster 120 to pass therethrough. A loop, closed or non-closed, of any shape having a sufficiently small maximum diameter (and/or having a gap of sufficiently small dimensions) that second attachment member 118 and length adjuster 120 cannot fit therethrough effectively creates a minimum and maximum length of the portions of the joined belly straps that encircle the animal proximate its waist area or belly area (or in other words around its torso proximate its hind legs, or closer to its hind legs than its fore legs). This allows the animal some comfort due to the harness not being able to tighten too much around the waist, but also prevents or hinders the animal from escaping the harness by this portion of the harness not being able to lengthen and open up sufficiently for the animal to extricate itself therefrom (until a user manually decouples first attachment member 114 and second attachment member 118 or lengthens second adjustable belly strap 116 using length adjuster 120).

In implementations the adjustable back strap is permanently attached to the strap coupler (such as by being overlapped upon itself and stitched together proximate strap coupler 110) but is nevertheless configured to slide along it (such as by a non-stitched portion creating a slidable through-hole). In other implementations the adjustable back strap could be removably attached to the strap coupler (such as with hook-and-loop fasteners instead of stitching at the overlapping portions). Strap coupler 110 includes an opening 111. Opening 111 is wide enough for a second adjustable belly strap 116 to slide therethrough but not wide enough to allow the second attachment member 118 or length adjuster 120 to pass therethrough—effectively retaining the second adjustable belly strap coupled with the strap coupler and effectively facilitating, at least in part, a minimum and maximum size for the loop formed by the joined belly straps. In implementations the second adjustable belly strap comprises a largest width (orthogonal to its longest length when laid flat) that is shorter or smaller than the opening 111, to make the second belly strap more easily slidable therethrough—though in other implementations it could be wider than the opening and could simply easily slide therethrough due to its ability to easily deform or bend while sliding therethrough.

Harness 100 includes a first belly strap 112. First belly strap 112 is affixed (in some cases permanently, in others removably) to strap coupler 110 and may slide thereon. First belly strap 112 includes a first attachment member 114 at its distal end. First attachment member 114 in the shown implementation is a male buckle member, though in other implementations it could be a female buckle member or an attachment mechanism other than a buckle member. As discussed briefly above, harness 100 also includes a second adjustable belly strap 116. Second adjustable belly strap 116 extends (and slides) through strap coupler 110 and includes a second attachment member 118 at one end and a leash coupler 122 at the other end. Second attachment member 118 in the shown example is a female buckle member, though in other implementations it could be a male buckle member or an attachment mechanism other than a buckle member. In one example, second attachment member 118 connects permanently to second adjustable belly strap 116, though in other implementations it could be removable. In the embodiment of FIGS. 2-3 first attachment member 114 and second attachment member 118 connect together and are detachable. Leash coupler 122 in this implementation is a D-ring (which could form a closed loop or could form a non-closed loop having a gap therein allowing manual sliding of a strap through the gap to couple the strap thereto—for example a loop sewn into a strap could be releasably secured around the D-ring by a loop portion of the strap being slid through the gap), though the leash coupler could instead be any other ring-like structure or non-ring shaped element (square, rectangular, polygonal, or any other regular or irregular shaped), forming a closed loop or a non-closed loop having a gap, and as shown in FIGS. 8-9 it may be configured for receiving a leash 204. In addition, second adjustable belly strap 116 includes a length adjuster 120. Length adjuster 120 allows for adjustment of the length of second adjustable belly strap 116. In one example, length adjuster 120 includes a tri-glide or sliding tension lock. In the embodiment shown in the figures the second adjustable belly strap 116 runs from second attachment member 118 through strap coupler 110, length adjuster 120 and through leash coupler 122. In implementations the second adjustable belly strap runs from the second attachment member through the strap coupler, through the length adjuster 120, and through the leash coupler 122. In implementations the leash coupler is not permanently affixed to any given point along the second adjustable belly strap to allow it to slide to the distal end of the second adjustable belly strap regardless of the adjusted length of the second adjustable belly strap. In some cases the leash coupler could be excluded, an end of the second belly strap opposite second attachment member 118 could be secured to the strap coupler instead of simply passing through its opening (for example the end could be doubled over and stitched/sewed to itself similar to first belly strap 112), and the length adjuster 120 could adjust a length of the belly/waist portion while a leash could be attached to the strap coupler. Nevertheless, such a configuration would not result in natural tightening of the loop around the animal's waist or belly when the animal pulls tightly, and so though simpler and having fewer components, has tradeoffs.

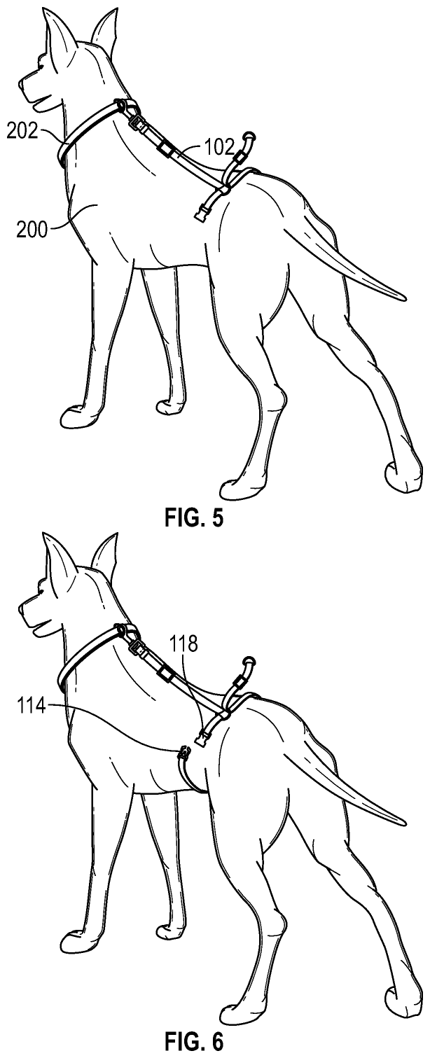

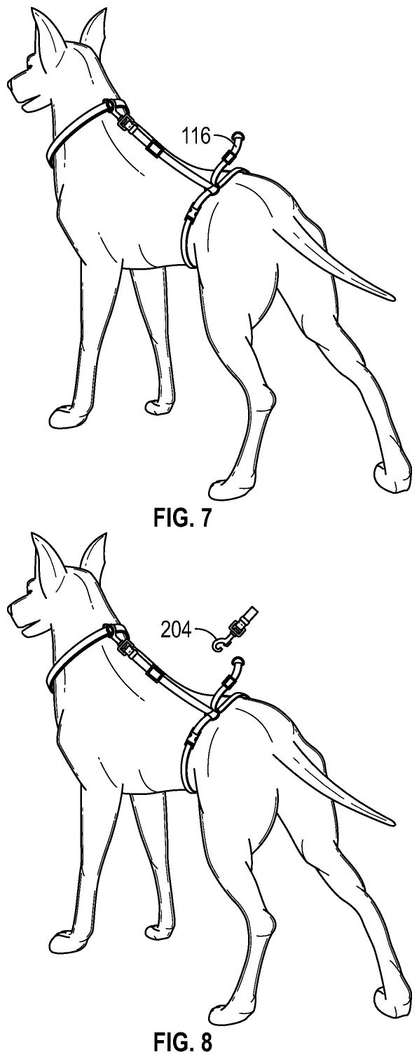

FIGS. 4 through 9 show various steps of securing harness 100 with an animal 200. FIG. 4 shows the collar coupler 106 about to be secured to collar 202. After coupling the collar coupler 106 to collar 202, the length of adjustable back strap 102 may be adjusted, as shown in FIG. 5. First belly strap 112 and second adjustable belly strap 116 are stretched around the waist area of animal 200 (or an area along the animal's torso proximate and in front of its hind legs), as shown in FIG. 6. First attachment member 114 and second attachment member 118 are connected/secured or coupled together (which may require using length adjuster 120 to adjust the length of second adjustable belly strap 116). The second adjustable belly strap may be adjusted so that it is at least partially against or abutting the animal's torso or waist, but so that it is not tight or uncomfortable, as shown in FIG. 7. Leash 204 connects to or couples with leash coupler 122, as shown in FIG. 8. FIGS. 8 and 9 accordingly show the harness 100 in a secured configuration (i.e., secured to the animal) with the collar coupler being secured to collar 202 and a leash 204 being secured to leash coupler 122.

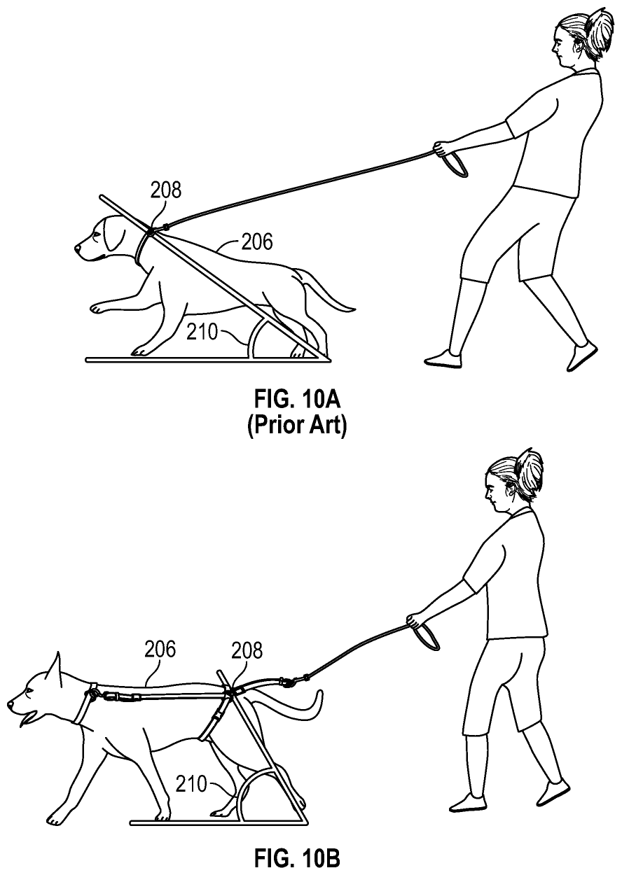

FIG. 10A shows a prior art leash and collar being used to restrain an animal. Because the leash connects to the collar at the front of the dog, the fulcrum 208 (i.e., the attachment point of the leash relative to the animal) is in front of the animal's center of mass. This allows the animal to pull strongly on the leash so that the user has to use more force to restrain the animal, as depicted in FIG. 10A with the user leaning backwards in an attempt to exercise more restraining force.

Referring now to FIG. 10B, when animal harness 100 is used, the leash 204 connects to second adjustable belly strap 116 at the belly or waist area so that the point of attachment for leash 204 is far back on animal 200, i.e., towards the animal's hind end. This moves the fulcrum 208 to behind the animal's center of mass 206. This configuration prevents or hinders the animal from effectively loading weight onto (or exercising pulling force against the user with) its hind legs, reducing the force the animal is able to exert pulling on leash 204. In addition, moving the attachment point of leash 204 to near the animal's hind end keeps the slack in the leash 204 behind the animal 200 so the leash doesn't get tangled in the animal's legs or trapped under animal 200.

It can also be seen in FIG. 10A that the prior art method results in a smaller size for angle 210 formed between the ground and a line connecting the fulcrum with the animal's hindmost foot (in some cases while the hindmost foot is on the ground, but in other cases not necessarily while the hindmost foot is on the ground) or a line connecting the fulcrum with a point along (or portion of) the animal's hindmost leg (in some cases while the hindmost foot is on the ground, but in other cases not necessarily while the hindmost foot is on the ground), whereas the use of animal harness 100 results in angle 210 being larger. The smaller angle for the prior art method is reflective of the animal's ability to load the hind legs with more force to be able to pull on the leash more strongly. FIG. 10B representatively illustrates the user restraining the animal with less force than in FIG. 10A, thus the user does not need to lean back in an attempt to apply increased restraining force.

The user can adjust the length of the straps to fit any sized animal. This saves time and money by allowing the user to avoid buying multiple harnesses over the growth period of an animal and/or by allowing the use of the same harness with a variety of animals. Length adjuster 104 and length adjuster 120 allow adjustment between maximum and minimum lengths. Additionally, length adjuster 120 allows the user to set a maximum size that the waist portion (first belly strap and second adjustable belly strap) can open, preventing the waist portion from loosening and expanding sufficient to allow the animal to escape the harness (even if there is no tension applied by the leash). The harnesses disclosed herein eliminate the requirement of constantly applying a large pulling/tension force on the leash while walking or running with an animal.

The presently disclosed harnesses are formed of straps that have smooth flat (or substantially flat and braided or woven) surfaces and are easy to put on with a simple clip to the collar, buckling around the waist, and clipping of the leash (and/or adjustment of the straps, as needed, for example the first time the harness is used with a given animal—though strap adjustment may not be needed for later uses with the same animal). The harness tightens around the animal's waist (due to movement of second adjustable belly strap 116 through the strap coupler) as the animal attempts to pull, evenly distributing pressure around the animal's midsection and taking pressure off its neck and, additionally, encouraging the animal to not pull hard by the gentle reminder of tightening around the waist. The harness has no spikes or pain inducing elements of many other no-pull products.

Any implementation of an animal harness disclosed herein could optionally include a collar and/or a leash as well, either integrally formed with other components of the harness or as one or more separate, releasable elements (such as a harness portion, a collar, and/or a leash provided together as a kit).

It is pointed out that in FIG. 3 some of the strap portions are sewn or otherwise fixedly joined together, but the strap portions are nevertheless not shown in this manner so that the different portions of the strap can be more clearly visible. But, for example, second adjustable belly strap 116 may be sewn or otherwise fixedly joined to itself proximate second attachment member 118, and first belly strap 112 may be sewn or otherwise fixedly joined to itself proximate strap coupler 110 and/or proximate first attachment member 114 (in FIG. 3 the strap ends overlap such that there would be three layers of first belly strap 112 sewn together in overlapping fashion, but in other implementations first belly strap 112 could be long enough that the end proximate first belly strap 112 and the end proximate first attachment member 114 do not overlap in this manner). Additionally, as indicated above, the drawings are not necessarily drawn to scale, and any of the straps could have any length as desired. Furthermore, any of the overlapping portions of the straps could have hook-and-loop fasteners thereon such as for further adjustments and ability to secure the harness strap dimensions to any desired length and secureness, etc. Although such hook-and-loop fasteners are not shown in the drawings, they are well-known enough that the practitioner of ordinary skill in the art will know how to incorporate them at any overlapping strap surfaces without the drawings including them.

It is further pointed out that collar coupler 106, first attachment member 114, and second attachment member 118 could have configurations other than those shown in the drawings. Each of these could use hook-and-loop fasteners, for example: collar coupler 106 coupling around a collar by doubling back a strap portion with hook and loop fasteners upon itself and first attachment member 114 and second attachment member 118 being strap ends with complementary hook-and-loop fasteners for the user to secure together at a desired length/configuration (though if a rigid buckle or other rigid element is not used for second attachment member 118 some element too large to fit within opening 111 would still be useful to provide the minimum waist length, as described above). Instead of buckle portions second attachment member 118 and first attachment member 114 could be biased clips (similar to the shown collar coupler 106), cords capable of being tied together, or any other elements capable of releasably securing together. Similarly, collar coupler 106 could be a cord capable of being looped around a collar and tied to itself (or two cords tied to one another around the collar), a strap with complementary buckles that buckle around the collar, or any other elements capable of releasably securing around the collar to secure the animal harness 100 to the collar. In some cases the leash coupler could simply be a loop in the end of the second adjustable belly strap opposite the second attachment member, for example a loop where the strap is doubled over upon itself or otherwise formed into a loop and sewn to itself, or otherwise secured with one or more rivets or heavy-duty staples or adhesive or with melt bonding or with some other securing technique. In any such case, a clip of the leash could simply be clipped to the formed loop to be releasably secured to the harness. It is also accurate to state that in any such case the leash coupler is coupled with the second belly strap.

In some implementations the strap coupler could simply be a loop in the end of the first belly strap 112 opposite the first attachment member 114 or in the end of the adjustable back strap 102 opposite the collar coupler 106, for example a loop where the respective strap is doubled over upon itself or otherwise formed into a loop and sewn to itself, or otherwise secured with one or more rivets or heavy-duty staples or adhesive or with melt bonding or with some other securing technique. In any case, the loop could be large enough so that second adjustable belly strap 116 can still easily slide therein for the functionality described herein.

In some implementations the collar coupler could simply be a loop in the end of the adjustable back strap, for example a loop where the respective strap is doubled over upon itself or otherwise formed into a loop and sewn to itself, or otherwise secured with one or more rivets or heavy-duty staples or adhesive or with melt bonding or with some other securing technique. In any case, the loop could be large enough so that the animal collar can be passed therethrough and then the animal collar secured around the animal's neck or elsewhere, to effectively secure the harness to the collar.

In some implementations the adjustable back strap 102 and first belly strap 112 could be integrally formed together and the strap coupler 110 could simply be an opening in the combined strap, such as formed with a large rivet or eyelet having an opening therein large enough for second adjustable belly strap 116 to easily slide therethrough, or a loop otherwise formed in the strap (such as using one or more knots of any variety) large enough for second adjustable belly strap 116 to easily slide therethrough. In any such case where adjustable back strap 102 and first belly strap 112 are integrally formed together and include some element or loop or knot integrally formed therein or therewith that forms strap coupler 110, it is still accurate to state that the adjustable back strap 102 would be coupled with the strap coupler 110 and that the first belly strap 112 would also be coupled with strap coupler 110 (it would also be accurate to say that adjustable back strap 102 and first belly strap 112 are coupled with one another).

In some implementations the swivel member may be excluded.

In some implementations length adjuster 120 could be a component of first belly strap 112 instead of second adjustable belly strap 116, or both the first belly strap and second belly strap could include a length adjuster.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of animal harnesses and related methods, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

Method steps disclosed anywhere herein, including in the claims, may be performed in any feasible/possible order. Recitation of method steps in any given order in the claims or elsewhere does not imply that the steps must be performed in that order-such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. An animal harness, comprising:
a collar coupler configured to be coupled with a collar of an animal;
a back strap coupled with the collar coupler and configured to extend toward hind legs of the animal along one of a back of the animal and a side of the animal;
a strap coupler coupled with the back strap;
a first belly strap coupled with the strap coupler;
a first attachment member coupled with the first belly strap;
a second belly strap coupled through an opening of the strap coupler and slidable therethrough;
a second attachment member coupled with the second belly strap; and
a leash coupler one of coupled with the second belly strap and integrally formed with the second belly strap, the leash coupler configured to couple with a leash;
wherein the first attachment member and the second attachment member are configured to be releasably secured together such that the first belly strap and the second belly strap form a loop around one of a waist area of the animal and a belly area of the animal; and
wherein the loop is configured to tighten around the animal, due to the second belly strap being slidable through the opening of the strap coupler, in response to a pulling force exerted by one of the animal and a user holding the leash.

2. The animal harness of claim 1, wherein the strap coupler forms a closed loop.

3. The animal harness of claim 2, wherein the closed loop is circular.

4. The animal harness of claim 1, wherein the back strap comprises a length adjuster configured to allow manual adjustment of a length of the back strap.

5. The animal harness of claim 1, further comprising a swivel member coupling the collar coupler with the back strap and configured to allow the collar coupler to swivel relative to the back strap.

6. The animal harness of claim 1, wherein the collar coupler is configured to be secured to the collar and is further configured to be manually releasable therefrom.

7. The animal harness of claim 6, wherein the collar coupler comprises a clip biased to a closed configuration and manually movable to an open configuration.

8. The animal harness of claim 1, wherein the back strap is slidably coupled with the strap coupler.

9. The animal harness of claim 1, wherein the first belly strap is slidably coupled with the strap coupler.

10. The animal harness of claim 1, wherein the second belly strap comprises a length adjuster configured to allow manual adjustment of a length of the second belly strap.

11. The animal harness of claim 10, wherein the length adjuster of the second belly strap is too large to pass through the opening of the strap coupler.

12. The animal harness of claim 1, wherein the second attachment member is too large to pass through the opening of the strap coupler.

13. The animal harness of claim 1, wherein the back strap is fixedly secured to the strap coupler but is slidable thereon, and wherein the first belly strap is fixedly secured to the strap coupler but is slidable thereon.

14. The animal harness of claim 1, wherein the loop has a minimum length and a maximum length, each of which is determined at least in part by an inability of a length adjuster of the second belly strap to fit through the opening or an inability of the second attachment member to fit through the opening.

15. An animal harness, comprising:
a collar coupler configured to be coupled with a collar of an animal;
a back strap coupled with the collar coupler and configured to extend toward hind legs of the animal along one of a back of the animal and a side of the animal, the back strap comprising a length adjuster configured to allow manual adjustment of a length of the back strap;
a strap coupler slidably coupled with the back strap, the strap coupler forming a loop;
a first belly strap slidably coupled with the strap coupler;
a first attachment member coupled with the first belly strap;
a second belly strap coupled through an opening of the strap coupler and slidable therethrough;
a second attachment member coupled with the second belly strap; and
a leash coupler coupled with the second belly strap, the leash coupler configured to couple with a leash;
wherein the first attachment member and the second attachment member are configured to be releasably secured together such that the first belly strap and the second belly strap form a loop around one of a waist area of the animal and a belly area of the animal;
wherein one of the first belly strap and the second belly strap comprises a second length adjuster configured to allow manual adjustment of a length of the loop formed by the first belly strap and the second belly strap; and
wherein the loop is configured to tighten around the animal, due to the second belly strap being slidable through the opening of the strap coupler, in response to a pulling force exerted by one of the animal and a user holding the leash.

16. The animal harness of claim 15, wherein the second belly strap comprises the second length adjuster, and wherein the second length adjuster is too large to pass through the opening of the strap coupler.

17. The animal harness of claim 15, wherein the second attachment member is too large to pass through the opening of the strap coupler.

18. The animal harness of claim 15, wherein the loop has a minimum length and a maximum length, each of which is determined at least in part by an inability of the second length adjuster to fit through the opening or an inability of the second attachment member to fit through the opening.

19. A method of use of an animal harness, comprising:
coupling a collar coupler of the animal harness with a collar of an animal, wherein the animal harness comprises:
a back strap;
a strap coupler coupled with the back strap;
a first belly strap coupled with the strap coupler;
a first attachment member coupled with the first belly strap;
a second belly strap coupled through an opening of the strap coupler and slidable therethrough;
a second attachment member coupled with the second belly strap; and
a leash coupler one of coupled with the second belly strap and integrally formed with the second belly strap;
extending the back strap toward hind legs of the animal along one of a back of the animal and a side of the animal;
releasably securing the first attachment member and the second attachment member together such that the first belly strap and the second belly strap form a loop around one of a waist area of the animal and a belly area of the animal;
coupling a leash with the leash coupler; and
tightening the loop around the animal, due to the second belly strap being slidable through the opening of the strap coupler, in response to a pulling force exerted by one of the animal and a user holding the leash.

20. The method of claim 19, further comprising preventing the loop from decreasing to below a minimum length and preventing the loop from increasing to above a maximum length, each of which is facilitated at least in part by an inability of a length adjuster of the second belly strap to fit through the opening or an inability of the second attachment member to fit through the opening.
